(19) United States
(12) Patent Application Publication
(10) Pub. No.: US 2008/0231763 A1
(43) Pub. Date: Sep. 25, 2008

(54) System and method for displaying and capturing images

(75) Inventors: Leonardo William Estevez, Rowlett, TX (US); James N. Malina, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/726,279

(22) Filed: Mar. 21, 2007

(51) Int. Cl. H04N 9/31

(52) U.S. Cl. 348/744; 348/E09.025

(57) ABSTRACT

A system for displaying and capturing images with a portable device includes a projector to project an image, a position sensor to determine positional information, and a processor coupled to the projector and to the position sensor. The processor adjusts the image based on the positional information. The position sensor detects the location and orientation of the portable device so that the processor adjusts the image to display only a portion of the image encompassing a point of view pointed to by the portable device. Displaying a portion of the image reduces projector complexity and processing/data requirements. The use of the position sensor may also help reduce processing/data requirements when capturing images.

### TECHNICAL FIELD

The present invention relates generally to a system and method for displaying and capturing images, and more particularly to a system and method for displaying and capturing images with a portable device.

### BACKGROUND

The display of images and video in a wide area, such as in a domed theater or a virtual reality environment may require that a large amount of image information be displayed. This requirement may impose significant performance requirements on a display system used to display the images. For example, a computer system used to generate the images to be displayed in a virtual reality system may require a large amount of computational power as well as data storage and data bandwidth to generate and transfer image data required to display the virtual environment. The large computational and data requirements may prevent the creation of a small form-factor display system that may be used in such environments.

However, the resolution of the human visual system is not continuous throughout the entire field of view. Rather, the resolution may rapidly and smoothly decrease from a human viewer's point of view. For example, at a little more than two degrees from the point of view, the resolution may be decreased by more than a factor of two and at about 20 degrees from the point of view, the resolution may be down by approximately a factor of ten. Therefore, it may not be necessary to display the entirety of the image at full resolution. Rather, only a small portion of the image may need to be displayed at full resolution and the remainder of the image may be displayed at a lower resolution.

In order to significantly reduce the computational power needed to generate the image data and the data capacity and transfer bandwidth, a display system, such as one utilizing a digital micromirror device (DMD) microdisplay, may project an image that encompasses the human viewer's point of view at full resolution plus a relatively small area around the point of view at continually decreasing resolution. Such a display system may need to be able to detect changes in the human viewer's point of view along with changes in the human viewer's position. Similarly, an image capture system may reduce data transfer rates and storage requirements by capturing at full resolution only image data that correspond to the human viewer's point of view.

### SUMMARY OF THE INVENTION

These and other problems are generally solved or circumvented, and technical advantages are generally achieved, by embodiments of a system and a method for displaying and capturing images with a portable device.

In accordance with an embodiment, an electronic device is provided. The electronic device includes a projector configured to project an image, a position sensor configured to determine positional information, and a processor coupled to the projector and to the position sensor. The processor adjusts the image based on the positional information.

In accordance with another embodiment, a method for displaying an image is provided. The method includes determining a current position, adjusting the image based on the current position, and displaying the image at a location based on the current position.

In accordance with another embodiment, a method for capturing a sequence of images is provided. The method includes determining a current position, capturing an image, storing the image and the current position. The method also includes repeating the determining, the capturing, and the storing for each image in the sequence of images.

An advantage of an embodiment is that the displaying (and capturing) of images within a human viewer's point of view may reduce the image display and capture requirements of a display and/or capture device, enabling the use of a portable device, which may greatly increase the desirability of such a system. In other words, the display and/or capture device may be smaller in size with a lower power requirement.

A further advantage of an embodiment is that the use of a portable device to display (and capture) images may accelerate the widespread acceptance of the embodiment due to a potentially smaller investment in hardware as well as the reduced requirements for displaying and capturing images.

Yet another advantage of an embodiment is that the display and/or capture devices may be enabled, permitting groups of viewers to share what every member of the group is seeing and/or capturing.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIGS. 1a through 1e are diagrams of portable electronic devices used to display and capture image data, and techniques for illuminating a microdisplay used in displaying image data and manipulating light;

FIGS. 2a and 2b are diagrams of top and isometric views of a viewer using a portable electronic device to display images;

FIGS. 3a through 3d are diagrams of a viewer using a portable electronic device to capture images, a sequence of images, a composite image generated from the sequence of images, and a reduction in image data by using position information; and

FIGS. 4a and 4b are diagrams of sequences of events in the displaying and capturing of images.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a portable electronic device capable of displaying and capturing images utilizing positional sensors to detect a point of view of a viewer utilizing the portable electronic device, wherein the displaying of the images makes use of a DMD. The invention may also be applied, however, to portable electronic devices using other forms of display technology, such as transmissive and reflective liquid crystal, liquid crystal on silicon, ferroelectric liquid crystal on silicon, deformable micromirrors, and so forth.

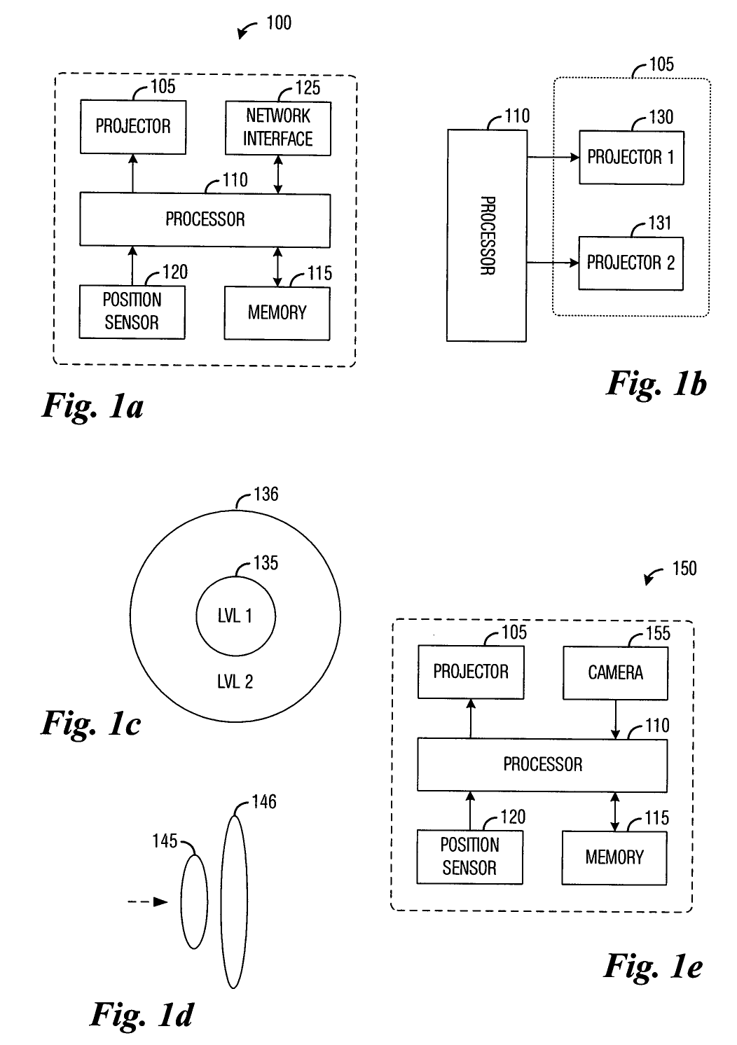

With reference now to FIGS. 1a through 1e, there are shown diagrams illustrating portable electronic devices for use in displaying and capturing images. Also shown is a diagram illustrating a detailed view of a projector, a haloed light pattern, and a flare lens system. The diagram shown in FIG. 1a illustrates an exemplary embodiment of a portable electronic device 100 that may be used to display images. The portable electronic device 100 includes a projector 105 that may be used to display the images. The projector 105 may be a microdisplay-based projection display system, wherein the microdisplay may be a DMD, a transmissive or reflective liquid crystal display, a liquid crystal on silicon display, ferroelectric liquid crystal on silicon, a deformable micromirror display, or another display.

The projector 105 may utilize a wideband light source (for example, an electric arc lamp), a narrowband light source (such as a light emitting diode, a laser diode, or some other form of solid-state illumination source). The projector 105 may also utilize a light that may be invisible to the naked eye, such as infrared or ultraviolet. These lights may be visible if a viewer wears a special eyewear or goggle, for example. The projector 105 and associated microdisplay, such as a DMD, may be controlled by a processor 110. The processor 110 may be responsible for issuing microdisplay commands, light source commands, moving image data into the projector 105, and so on. A memory 115 coupled to the processor 110 may be used to store image data, configuration data, color correction data, and so on.

A position sensor 120, also coupled to the processor 110, may be used to detect changes in position of the portable electronic device 100. For example, the position sensor 120 may include gyroscopic devices, such as accelerometers, angular accelerometers, and so on, non-invasive detecting sensors, such as ultrasonic sensors, and so forth, inductive position sensors, and so on, that may detect motion (or changes in position) in the portable electronic device 100. The position sensor 120 may also be able to detect changes in angle, which may be used by the processor 110 to determine a point of view of the portable electronic device 100. The processor 110 may then make adjustments to an image to be projected by the projector 105. Additional sensors may be included in the position sensor 120, such as a global positioning system (GPS) sensor that may be used to detect changes in location of the portable electronic device 100 or may be used in combination with the gyroscopic devices and others, to enhance the performance of the sensors.

The portable electronic device 100 may be a small device that may be held in the hand of the viewer. Alternatively, the portable electronic device 100 may be attached to a helmet, hat, glasses, or some other form of headwear or be integrated into a helmet, hat, glasses, or some other form of headwear that may be worn by a viewer. The portable electronic device 100 may also be worn on the body of the viewer, for example, by attachment to a belt worn by the viewer. The portable electronic device 100 may also include a network interface 125. The network interface 125 may permit the portable electronic device 100 to communicate with other electronic devices. The communications may occur over a wireless or wired network. For example, the network interface 125 may permit the portable electronic device 100 to network with other portable electronic devices and permit viewers of the different devices to see what each other are seeing. This may have applications in gaming, virtual product demonstrations, virtual teaching, and so forth.

Although shown as a single projector, the projector 105 may comprise two or more projectors, with each projector used to project a different image or a different portion of a single image. As shown in FIG. 1b, the projector 105 may comprise two projectors, a first projector 130 may project an image that corresponds to a viewer's point of view and displays the image at full resolution. The projector 105 may include a second projector 131 may project an image that corresponds to a remainder of the image that lies outside of the viewer's point of view. The second projector 131 may project images at a lower resolution than the first projector 130. For example, the first projector 130 may have a 30 degree field of view while the second projector 131 may have a 60 degree field of view. The image being projected by the first projector 130 may not need to be also projected by the second projector 131, even at the lower resolution.

The luminosity of light as it is distributed over a distance will tend to decrease. Therefore, the light used to project portions of the image outside of the point of view may need to be at a higher luminosity than light used to project portions of the image inside the point of view. It may be possible to utilize a light of greater luminosity in the second projector 131 than the light in the first projector 130. Alternatively, in a portable electronic device that uses a single projector to project images, the light used to illuminate the microdisplay, for example, a DMD, may be haloed, wherein the light used to display a portion of the image within the point of view will be at a lower luminosity than the light used to display a portion of the image outside of the point of view. A diagram shown in FIG. 1c illustrates a light pattern that may be used to illuminate a microdisplay. The light pattern includes a first zone 135 with a luminosity of “LVL 1” and a second zone 136 with a luminosity of “LVL 2.” More than two zones may be used.

An alternative to the use of a haloed light to illuminate the microdisplay may be a flare lens system, as shown in FIG. 1d. A flare lens system may include a first lens 145 that may act as a condenser lens and a second lens 146 that may act as a spreader lens. The first lens 145 may be used to provide light for a point of view portion of an image being displayed and the second lens 146 may be used to provide for portions of an image outside of the point of view. A resulting image may be a circular region in a center that corresponds to a high concentration of pixels modulated by the microdisplay (corresponding to the point of view) and a surrounding halo of image pixels, wherein a single image pixel in the surrounding halo may encompass a surface area roughly equal to a number of pixels in the point of view. For example, a single pixel in the surrounding halo may cover a surface area approximately equal to four to eight pixels in size. A single pixel in the surrounding halo area may be an average (mathematical average, weighted average, and so forth) of the pixels within the point of view portion. The first lens 145 and the second lens 146 may be individual lenses, as shown, or they may be bonded together, or they may be formed via extrusion and/or molded into a single unit. A flare lens system may include more than two lenses.

The diagram shown in FIG. 1e illustrates an exemplary embodiment of a portable electronic device 150 that may be used to display and capture images. Like the portable electronic device 100, the portable electronic device 150 may include the projector 105 for use in displaying images, the processor 110 to perform necessary computations and control operations, the memory 115 for storage, and the position sensor 120 to detect the position (and change of position) of the viewer. The portable electronic device 150 may also include a camera 155 (or more simply, an image sensor). The camera 155 may be used to capture images. The camera 155 may include more than one image sensor, to enable the capture of three-dimensional images, for example.

The images captured by the camera 155 may be marked with position information provided by the position sensor 120 to enable the proper location of the images taken by the camera 155. The processor 110 may in real-time (or at a later time) create a composite image from the images taken by the camera 155. For example, a sequence of multiple pictures may be joined (stitched) together to form a panoramic image. The viewer of the portable electronic device 150 may need to place the device 150 into a special mode to enable the capture of images. In an alternative embodiment, the portable electronic device 150 may not include the projector 105 and operate solely as an image capture device.

As with the portable electronic device 100, the portable electronic device 150 may be a small device that may be held in the hand of a viewer. Alternatively, the portable electronic device 150 may be attached to a helmet, hat, glasses, or some other form of headwear or be integrated into a helmet, hat, glasses, or some other form of headwear. The portable electronic device 150 may also be worn by the viewer, for example, by attachment to a belt worn by the viewer.

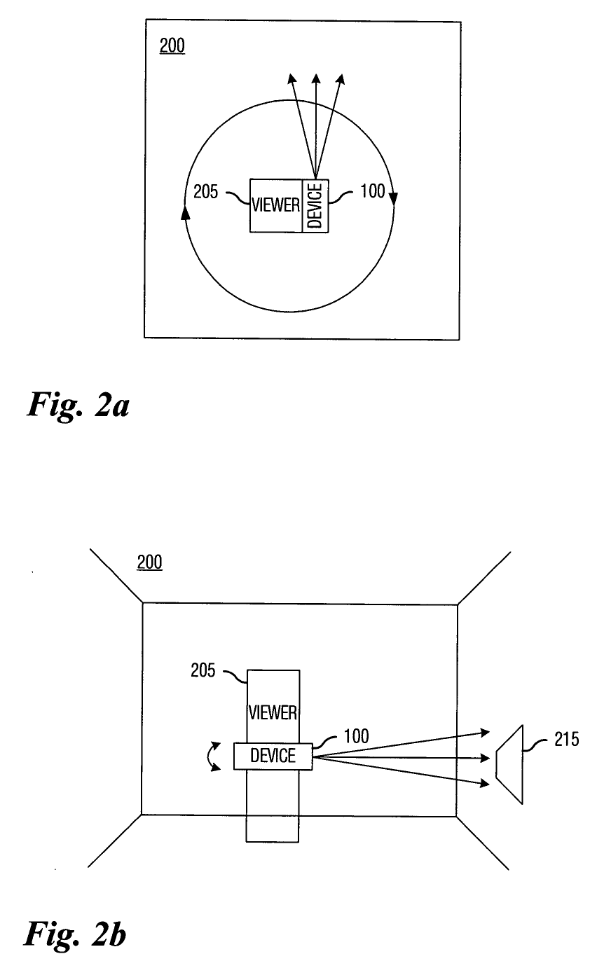

With reference now to FIGS. 2a and 2b, there are shown diagrams illustrating a top view and an isometric view of a viewer making use of a portable electronic device to display images. The diagram shown in FIG. 2a illustrates a top view of a viewing deck 200 containing a viewer 205 and a portable electronic device 210. The portable electronic device 100 may be capable of displaying images, capturing images, or both. The portable electronic device 100 may be held by the viewer 205 or attached to the viewer 205, via a hat or a helmet, for example, as the viewer 205 rotates in the viewing deck 200. The viewing deck 200 may be a room optimized to improve image quality, for example, the walls of the viewing deck 200 may be specially coated with a material, such as a Lambertian reflective white surface, to improve image brightness and contrast.

In addition to rotating, the viewer 205 may also pivot. The diagram shown in FIG. 2b illustrates an isometric view of the viewing deck 200. With the portable electronic device 100 attached to the viewer's head, the viewer 205 may pivot his/her head up and down as well as rotate, while if the portable electronic device 100 is being held by the viewer 205, the viewer 205 may move the portable electronic device 100 up/down/left/right as well as rotate. The portable electronic device 100 may be able to detect the movements and changes in position of the viewer 205 (or itself) and project an image 215 onto walls of the viewing deck 200 that correspond to a point of view of the viewer 205. The portable electronic device 100 may need to be able to compute necessary adjustments to the image 215, such as keystoning and translating, to ensure a proper image. Additionally, the viewer 205 may be able to have the portable electronic device 100 zoom in and out on the image 215 that is currently being displayed.

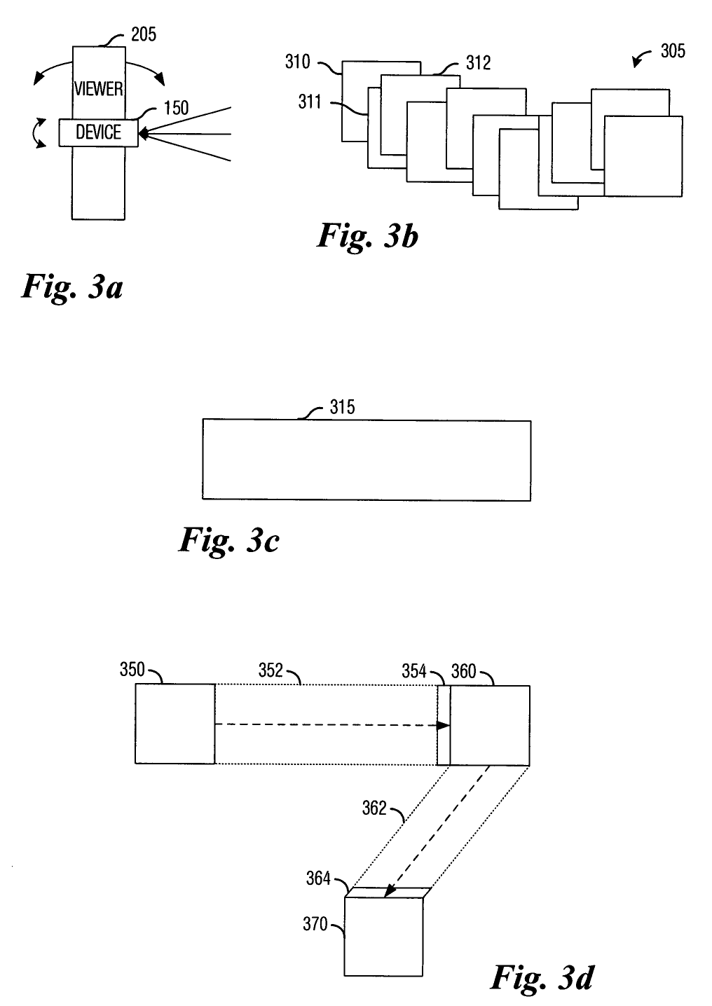

With reference now to FIGS. 3a through 3d, there are shown diagrams illustrating the use of a portable electronic device to capture images. Also shown are diagrams illustrating the use of position information to combine images and to reduce data storage requirements. In addition to displaying images, the portable electronic device 150 may be able to capture images. The diagram shown in FIG. 3a illustrates the viewer 205 pivoting and rotating while the portable electronic device 150 captures images. The portable electronic device 150 may capture a single image or a sequence of images based on an operating mode of the portable electronic device 150. The portable electronic device 150, when capturing a sequence of images, may be able to combine the images in the sequence of images into a single image. The diagram shown in FIG. 3b illustrates a sequence of images 305 captured by the portable electronic device 150 as the viewer 205 pivots and/or rotates. The sequence of images 305 may include individual images, such as image 310, 311, and 312. The portable electronic device 150 may be configured to capture an image periodically or after the viewer 205 has sufficiently changed position or point of view. For example, the portable electronic device 150 may capture an image every quarter of a second or after the viewer 205 has rotated or pivoted two or three degrees.

The sequence of images 305 may then be combined into a single image 315, as shown in FIG. 3c. The combining of the images in the sequence of images 305 into the single image 315 may make use of position information from the portable electronic device 150. The use of position information, such as from a GPS receiver, may enable the use of a single camera to capture three-dimensional images. The position information may be used to properly sequence the images as well as help in removing overlap that may be present in consecutive images. The combining of the images in the sequence of image 305 may occur in real-time as the images are being captured by the portable electronic device 150 or the combining may occur at a later time when the portable electronic device 150 is not actively capturing images or displaying images. Alternatively, the combining of the images in the sequence of images 305 may occur on a separate processing device, such as an external computer that may attach to the portable electronic device 150 by a wired or wireless connection, which may be required if the combining requires more computing power than available in the portable electronic device 150.

The position information provided by the position sensor 120 of the portable electronic device 150 may also be used to help reduce image data storage requirements. The diagram shown in FIG. 3d illustrates a point of view of the portable electronic device 150 as the viewer moves the portable electronic device 150. The viewer moves the portable electronic device 150 from a first point of view 350 to a second point of view 360 and to a third point of view 370. In moving from the first point of view 350 to the second point of view 360, the position sensor 120 may report that the change in position is zero (0) pixels vertical and 120 pixels horizontal. If the position sensor 120 has an error margin of two (2) pixels, then the portable electronic device 150 may not have to store a strip of pixels 118 wide by the height of the point of view tall (shown in FIG. 3d as block 352). The portable electronic device 150 may have to store a strip of pixels two (2) pixels wide by the height of the point of view tall (shown in FIG. 3d as block 354) to provide compensation for the error of the position sensor 120. Similarly, as the point of view changes from the second point of view 360 to the third point of view 370, the position sensor 120 may report a change in position of 30 pixels vertical and 20 pixels horizontal. Given the two pixel error margin of the position sensor 120, the portable electronic device 150 may not have to store a strip of pixels 28 pixels tall and 18 pixels wide (shown in FIG. 3d as block 362). Rather, portable electronic device 150 may have to store a strip of pixels two pixels high by the width of the point of view wide (shown in FIG. 3d as block 364).

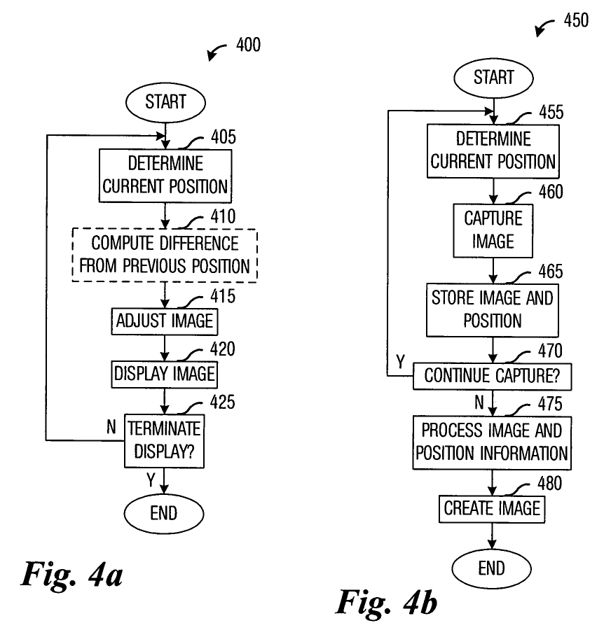

With reference now to FIGS. 4a and 4b, there are shown diagrams illustrating sequences of events in displaying images and capturing images, respectively. The diagram shown in FIG. 4a illustrates a sequence of events 400 in displaying images using a portable electronic device, such as the portable electronic device 100, wherein the portable electronic device 100 may make use of position information to display a portion of an image at full resolution. The displaying of images may begin with a determining of a current position (block 405). The determining of the current position may involve a determination of the physical location of the viewer 205 and the portable electronic device 100 as well as any rotation or pivot (incline or decline) present in the portable electronic device 100. Collectively, the rotation and/or pivot angles combine to create an angle of incidence. This information may be used to determine the viewer's point of view.

An optional operation may be performed if the image being displayed is not the first image to be displayed, wherein a difference between the current position and a previous position may be computed (block 410). The current position (or the difference in the current position and the previous position) may then be used to make adjustments in the image to be displayed (block 415). The use of the difference may simplify the computation of the necessary adjustments in the image to be displayed. Once the adjustments have been made to the image to be displayed, the image may then be displayed (block 420). As discussed previously, the image may be displayed by more than one projector and may utilize a haloed light or a flare lens system.

If the portable electronic device 100 is to continue displaying images (block 425), then the determining of the current position, the optional computing of the difference between the current position and the previous position, the adjusting of the image, and the displaying of the image may be repeated. If the portable electronic device 100 is to discontinue displaying images, then the sequence of events 400 may terminate.

The diagram shown in FIG. 4b illustrates a sequence of events 450 in capturing images using a portable electronic device, such as the portable electronic device 150, wherein the portable electronic device may make use of position information to capture images. The capture of images may begin with a determining of a current position (block 455). The determining of the current position may involve a determination of the physical location of the viewer 205 as well as any rotation or pivot (incline or decline) present in the viewer's head. This information may be used to determine the viewer's point of view.

Once the position information has been determined, the image may be captured by the portable electronic device 150 (block 460). Along with the image data, the position information may be stored (block 465). As discussed previously, not all of the image data visible to the camera 155 of the portable electronic device 150 may need to be stored. For example, given a specific height and width of the point of view and an error margin for the position sensor 120, the portable electronic device 150 may need to store only the image data corresponding to the point of view (as computed from the position information from the position sensor 120) plus a small amount of image data corresponding to the error margin of the position sensor 120. With the image data and the position information stored (block 465), the determining of a current position, the capturing of the image data, and the storing of the image data and the position information may be repeated if the portable electronic device 150 is configured to continue capturing images (block 470).

If the capturing of images is discontinued, then the portable electronic device 150 may begin to process the image data and the position information stored (block 475) to create an image (block 480). Alternatively, the image data and the position information may be downloaded to a standalone processor to perform the processing. Depending upon the processing capabilities of the portable electronic device 150 as well as the size and complexity of the images being captured, the portable electronic device 150 may be capable of performing the processing in real-time. Performing the processing in real-time may occur before or after the storing of the image data and the position information (block 465) and before a determination if the portable electronic device 150 is to continue the capture of additional images.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An electronic device comprising:
a projector configured to project an image;
a position sensor configured to determine positional information; and
a processor coupled to the projector and to the position sensor, the processor configured to adjust the image based on the positional information.

2. The electronic device of claim 1, wherein the positional information comprises a location.

3. The electronic device of claim 2, wherein the processor is configured to compute a point of view from the positional information.

4. The electronic device of claim 1, wherein the image is translated and keystoned based on the positional information.

5. The electronic device of claim 1, further comprising a camera coupled to the processor, the camera configured to capture images.

6. The electronic device of claim 5, wherein the processor is further configured to compute a composite image based on images captured by the camera and positional information associated with each image.

7. The electronic device of claim 1, wherein the position sensor comprises a sensor selected from the group consisting of a gyroscopic sensor, a global positioning system sensor, an accelerometer, angular accelerometer, ultrasonic sensor, inductive position sensor, and combinations thereof.

8. The electronic device of claim 1, wherein the projector comprises a digital micromirror device-based projection display system.

9. The electronic device of claim 8, wherein the projector comprises:
a first projector configured to display a first portion of the image at a first resolution; and
a second projector configured to display a second portion of the image at a second resolution.

10. The electronic device of claim 1 further comprising a network interface coupled to the processor and to a communications network, the network interface configured to permit communications between the electronic device and other devices coupled to the communications network.

11. A method for displaying an image, the method comprising:
determining a current position;
adjusting the image based on the current position; and
displaying the image at a location based on the current position.

12. The method of claim 11, wherein the determining comprises:
determining a location of a device used to display the image; and
determining an angle of incidence.

13. The method of claim 11, further comprising after the determining, computing a difference between the current position and a previous location.

14. The method of claim 13, wherein the adjusting is based on the difference.

15. A method for capturing a sequence of images, the method comprising:
determining a current position;
capturing an image;
storing the image and the current position; and
repeating the determining, the capturing, and the storing for each image in the sequence of images.

16. The method of claim 15, wherein the determining, the capturing, and the storing occurs periodically.

17. The method of claim 15, wherein the capturing and the storing occurs in response to a determining that the current position has changed from a previous position by more than a specified amount.

18. The method of claim 15, further comprising, after the repeating, creating a composite image based on the images in the sequence of images and their respective current positions.

19. The method of claim 15, wherein the current position comprises a location and an angle of incidence.

20. The method of claim 15, wherein the current position is determined with an error margin, and wherein the capturing comprises capturing image data corresponding to a point of view as specified by the current position plus image data corresponding to the error margin.
